(19) United States
(12) Patent Application Publication
(10) Pub. No.: US 2024/0221777 A1
(43) Pub. Date: Jul. 4, 2024

(54) APPARATUS, METHOD AND COMPUTER PROGRAM CODE FOR PROCESSING AUDIO STREAM

(71) Applicant: Utopia Music AG, Zug (CH)

(72) Inventors: Linus Wahlgren, Zug (CH); Max Flach, Zug (CH)

(73) Assignee: Utopia Music AG, Zug (CH)

(21) Appl. No.: 18/686,266

(22) PCT Filed: Jul. 12, 2022
(86) PCT No.: PCT/EP2022/069393

§ 371 Date: Feb. 23, 2024

(30) Foreign Application Priority Data
Jul. 14, 2021 (EP) 21185503.6

(51) Int. Cl. G10L 25/54; G10L 25/18

(52) U.S. Cl. CPC G10L 25/54; G10L 25/18

(57) ABSTRACT

Apparatus, method, and computer program code for processing audio stream. The method includes: obtaining first peaks of an audio stream, wherein the first peak comprises a first peak amplitude at a first frequency and at a first time offset from a beginning of the audio stream; for each first peak, detecting a second peak in a window with a predetermined offset from the first peak, wherein the second peak comprises a second peak amplitude at a second frequency and at a second time offset from the beginning of the audio stream; and for each first peak, generating a fingerprint hash based on the first frequency, a time difference between the first time offset and the second time offset, a frequency difference between the first frequency and the second frequency, and an amplitude difference between the first amplitude and the second amplitude.

### FIELD

Various embodiments relate to an apparatus, method, and computer program code for processing an audio stream.

### BACKGROUND

The goal of fixing the issues with royalties in the music industry is challenging. Whenever an audio track is played on the radio, television, live, or sampled in a new recording, for example, the original song writer should get paid. For example, all radio stations worldwide need to be tracked against databases containing millions upon millions of audio recordings. While there exists audio recognition techniques, none of them on their own are accurate, scalable, and cost efficient enough for the described use case. Audio fingerprinting may need to be improved in order to overcome current limitations and reduce runtime costs in order to make it feasible to run on a global scale. Some fingerprint hashes may be so common that they become unusable. Also, similar intervals of the same frequency note may cause similar fingerprint hashes even if the tracks are different.

### BRIEF DESCRIPTION

According to an aspect, there is provided subject matter of independent claims. Dependent claims define some embodiments.

One or more examples of implementations are set forth in more detail in the accompanying drawings and the description of embodiments.

### LIST OF DRAWINGS

Some embodiments will now be described with reference to the accompanying drawings, in which

FIG. 1 illustrates embodiments of an apparatus for processing an audio stream;

FIG. 2 is a flow chart illustrating embodiments of a method for processing an audio stream;

FIG. 3 illustrates a spectrogram;

FIG. 4 illustrates peaks of a spectrogram; and

FIG. 5, FIG. 6, and FIG. 7 illustrate embodiments of matching recursively generated fingerprint hashes of an audio stream against stored fingerprint hashes of tracks.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

Reference numbers, both in the description of the embodiments and in the claims, serve to illustrate the embodiments with reference to the drawings, without limiting it to these examples only.

The embodiments and features, if any, disclosed in the following description that do not fall under the scope of the independent claims are to be interpreted as examples useful for understanding various embodiments of the invention.

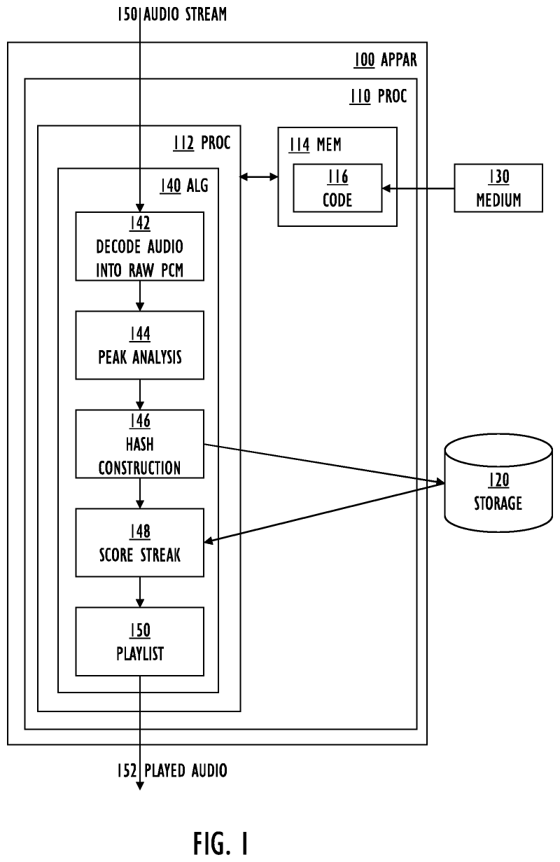

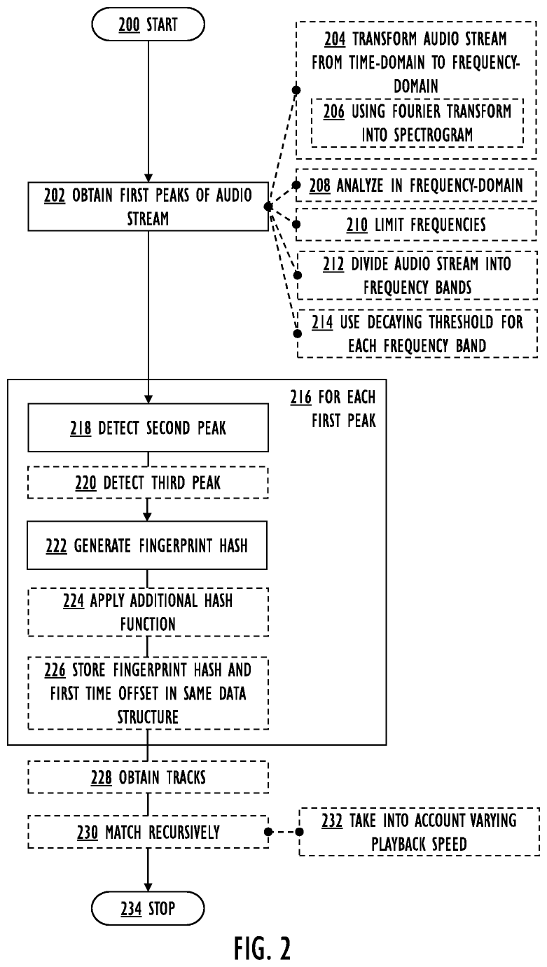

Let us study simultaneously FIG. 1 illustrating embodiments of an apparatus 100 for processing an audio stream 150, and FIG. 2 illustrating embodiments of a method for processing the audio stream 150.

The apparatus comprises one or more processors 110 configured to cause performance of the apparatus 100.

In an embodiment, the one or more processors 110 comprise one or more memories 114 including computer program code 116, and one or more processors 112 configured to execute the computer program code 116 to cause performance of the apparatus 100.

In an embodiment, the one or more processors 110 comprise a circuitry configured to cause the performance of the apparatus 100.

Consequently, the apparatus 100 may be implemented as one or more physical units, or as a service implemented by one or more networked server apparatuses. The physical unit may be a computer or another type of a general-purpose off-the-shelf computing device, as opposed to a purpose-build proprietary equipment, whereby research & development costs will be lower as only the special-purpose software (and not the hardware) needs to be designed, implemented, and tested. However, if highly optimized performance is required, the physical unit may be implemented with proprietary integrated circuits. The networked server apparatus may be a networked computer server, which operates according to a client-server architecture, a cloud computing architecture, a peer-to-peer system, or another applicable distributed computing architecture.

A non-exhaustive list of implementation techniques for the processor 112 and the memory 114, or the circuitry, includes, but is not limited to: logic components, standard integrated circuits, application-specific integrated circuits (ASIC), system-on-a-chip (SoC), application-specific standard products (ASSP), microprocessors, microcontrollers, digital signal processors, special-purpose computer chips, field-programmable gate arrays (FPGA), and other suitable electronics structures.

The term ‘memory’ 114 refers to a device that is capable of storing data run-time (=working memory) or permanently (=non-volatile memory). The working memory and the non-volatile memory may be implemented by a random-access memory (RAM), dynamic RAM (DRAM), static RAM (SRAM), a flash memory, a solid state disk (SSD), PROM (programmable read-only memory), a suitable semiconductor, or any other means of implementing an electrical computer memory.

The computer program code (or software) 116 may be written by a suitable programming language (such as C, C++, assembler or machine language, for example), and the resulting executable code may be stored in the memory 114 and run by the processor 112. The computer program code 116 implements a part of an algorithm 140 as the method illustrated in FIG. 2. The computer program code 116 may be in source code form, object code form, executable form, or in some intermediate form, but for use in the one or more processors 112 it is in the executable form. There are many ways to structure the computer program code 116: the operations may be divided into modules, sub-routines, methods, classes, objects, applets, macros, etc., depending on the software design methodology and the programming language used. In modern programming environments, there are software libraries, i.e. compilations of ready-made functions, which may be utilized by the computer program code 116 for performing a wide variety of standard operations. In addition, an operating system (such as a general-purpose operating system or a real-time operating system) may provide the computer program code 116 with system services.

An embodiment provides a computer-readable medium 130 storing the computer program code 116, which, when loaded into the one or more processors 112 and executed by one or more processors 112, causes the one or more processors 112 to perform the method of FIG. 2. The computer-readable medium 130 may comprise at least the following: any entity or device capable of carrying the computer program code 116 to the one or more processors 112, a record medium, a computer memory, a read-only memory, an electrical carrier signal, a telecommunications signal, and a software distribution medium. In some jurisdictions, depending on the legislation and the patent practice, the computer-readable medium 130 may not be the telecommunications signal. In an embodiment, the computer-readable medium 130 is a computer-readable storage medium. In an embodiment, the computer-readable medium 130 is a non-transitory computer-readable storage medium.

The algorithm 140 comprises the operations 142, 144, 146, 148, 150, but not all of them need to be implemented and run on the same apparatus 100, i.e., operations 142 and 144, for example, may be performed by another apparatus.

The method starts in 200 and ends in 234. The method forms a part of the algorithm 140 running in the one or more processors 110, mainly in the operations 144, 146, 148 and 150.

The operations are not strictly in chronological order in FIG. 2, and some of the operations may be performed simultaneously or in an order differing from the given ones. Other functions may also be executed between the operations or within the operations and other data exchanged between the operations. Some of the operations or part of the operations may also be left out or replaced by a corresponding operation or part of the operation. It should be noted that no special order of operations is required, except where necessary due to the logical requirements for the processing order.

In 202, first peaks of the audio stream 150 are obtained.

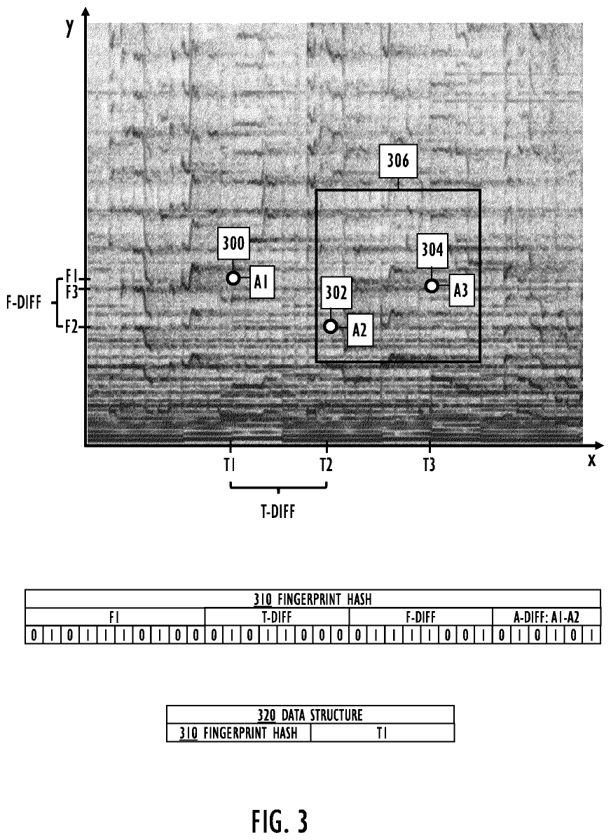

FIG. 3 illustrates a spectrogram of the audio stream 150. The x-axis represents time, and the y-axis represents frequency. An intensity of the colour represents an amplitude of a specific point with a specific frequency at a specific time: the darker the shade, the higher the amplitude.

One first peak 300 is shown in FIG. 3. The first peak 300 comprises a first peak amplitude A1 at a first frequency F1 and at a first time offset T1 from a beginning of the audio stream 150. Note that to increase legibility, the point 300 is coloured white, which does not describe the true magnitude of the first peak amplitude A1 using the correct shade.

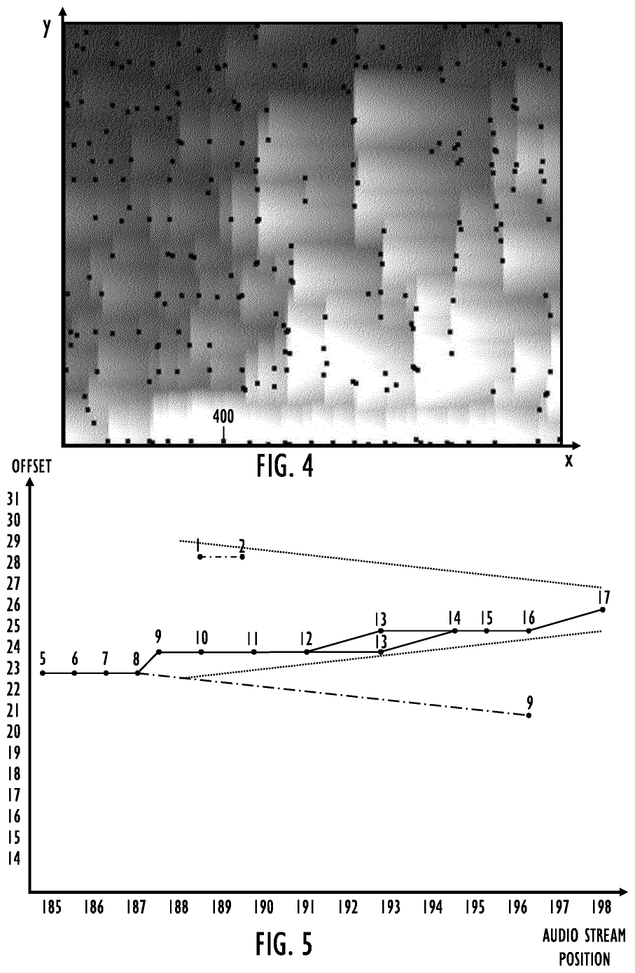

The first peaks 300 may be selected from among significant peaks of the audio stream 150. FIG. 4 illustrates the spectrogram with significant peaks 400. As can be seen when comparing the spectrogram of FIG. 4 with the spectrogram of FIG. 3, the amount of data is massively reduced.

In an embodiment, the obtaining in 202 comprises transforming in 204 the audio stream 150 from a time-domain to a frequency-domain, and analyzing in 208 the audio stream 150 in the frequency-domain to detect the first peaks 400.

In an embodiment, the transforming in 204 comprises using in 206 a Fourier to transform the audio stream 150 into a spectrogram describing audio amplitudes at different frequencies over time.

In an embodiment, the obtaining in 202 comprises limiting in 210 the audio stream 150 to a subset of a full frequency range of the audio stream 150. This may be implemented so that all frequencies of the audio stream 150 above a predetermined frequency threshold are cut out. Since most instruments and vocals reside within the 0-4000 Hz spectrum, all audio above it may be cut off.

In an embodiment, the obtaining in 202 comprises dividing in 212 the audio stream 150 into a predetermined number of frequency bands, and using in 214 a decaying threshold value for each frequency band to detect the first peaks 400. In the embodiment of FIG. 3, the y-axis may be divided into a predetermined number of frequency bands, into 256 adjacent and non-overlapping frequency bands, for example. Using the decaying threshold value in 214 may be used for each frequency as follows: when the current decaying threshold value for the frequency is surpassed by the current amplitude and the current amplitude is also the highest amplitude of the closest five measurements, the current peak is considered a significant peak, and when a significant peak occurs, the decaying threshold value is set to the current amplitude for this frequency and to the ones (=predetermined number of the closest frequencies) closest to it. The reasoning behind this approach is that as audio streams 150 are processed, an average gain in the song is not known. This approach only requires keeping five measurements of each frequency in a memory.

In an embodiment, the audio stream 150 may originate from a playback in the radio or television, for example. In 142, the audio stream 150 may be decoded into raw audio. Raw audio in a computer is usually represented using a pulse-code modulation (PCM): a series of bits (bit depth) representing different amplitudes sampled at uniform intervals known as a sample rate. One of the more common formats is using two 16-bit data units to represent left and right (stereo sound) channels with a sampling rate of 44.1 kHz. This means that 16×2×44100 bits or 176.4 kilobytes is a bitrate needed to represent one second of audio. Storing a 3-minute song in this format would take up roughly 32 megabytes, which is very inefficient. The format does not in itself contain any information regarding audio formatting, a song name, an author, or any other metadata. There are many coding formats used to package audio that describe the bit depth and sample rate and also enable compression, metadata embedding, DRM (Digital Rights management) and other related features. Some of the more common coding format for audio are MPEG Layer 3 (mp3), Waveform (wav) and Free Lossless Audio Codec (flac). Each of these are designed for specific use cases and have different bit depth, sample rate, channels, and sometimes even variable bitrates.

Comparing audio is not straightforward since two different audio streams 150 containing the same song may look vastly different. In 144, a spectrogram representing the audio stream 150 is analyzed as described to find significant peaks in the audio.

Audio files could be matched by comparing these peaks between different recordings at this point. However, this would not be very efficient with millions of songs and a hundred thousand audio streams running simultaneously. The way we get around this issue is to generate fingerprint hashes in 146 based on the significant peaks and their relation to each other.

In 216, 218, for each first peak 300, a second peak 302 is detected in a window 306 with a predetermined offset from the first peak 300, wherein the second peak 302 comprises a second peak amplitude A2 at a second frequency F2 and at a second time offset T2 from the beginning of the audio stream 150. The second peak 302 may have the highest amplitude within the window 306. The frequency F2 of the second peak 302 may not have the same exact frequency F1 of the first peak 300, as in this way more uniqueness for a fingerprint hash 310 may be obtained. The same exact frequency is avoided due to the fact that it is too common pattern to have the same note repeated within a short time window.

In an embodiment, the window 306 with the predetermined offset from the first peak 300 covers a predetermined amount of frequency spectrum both above and below the first frequency F1. As shown in FIG. 3, the window 306 with the predetermined offset is with a predetermined time offset forward in the time dimension. The window 306 may be defined so that it is centred around the first frequency F1. The reason behind the window height and the fact that it is centred around the same frequencies is that different equalizer settings and microphone recordings tend to distort some frequencies more than others. For instance, most cell phone microphones tend to almost lose the lower frequencies entirely but keep the upper frequencies intact. If two peaks were used, one from a high frequency and the other from a low frequency, the cell phone microphone would never be able to match the audio since it is missing the lower spectrum.

In 216, 222, for each first peak 300, a fingerprint hash 310 is generated based on the first frequency F1, a time difference T-DIFF between the first time offset T1 and the second time offset T2, a frequency difference F-DIFF between the first frequency F1 and the second frequency F2, and an amplitude difference A-DIFF between the first amplitude A1 and the second amplitude A2. The fingerprint hash 310 (also known as a hash value, hash code, or digest) may be generated by any suitable hash function.

In an embodiment shown in FIG. 3, the fingerprint hash 310 uses 32 bits: the first 10 bits describe the first frequency F1, the next 8 bits describe the time difference T-DIFF, the following 8 bits describe the frequency difference F-DIFF, and the final 6 bits describe the amplitude difference A-DIFF.

While processing a song as the audio stream 150, an output of about 300 fingerprint hashes in a minute or five per second is an appropriate target. This may vary quite a bit since it depends on how many significant peaks the audio stream 150 produces. The inventors have tweaked the hash construction method in 146 output slightly more than the target and then filter out the lower amplitude ones. While making the fingerprint hashes more consistent, this helps a lot with calmer and more quiet audio streams.

In an embodiment also illustrated in FIG. 3, for each first peak 300, also a third peak 304 is detected in the window 306 with the predetermined offset from the first peak 300 in 216, 220. The third peak 304 comprises a third peak amplitude A3 at a third frequency F3 and at a third time offset T3 from the beginning of the audio stream 150. Additionally, for each first peak 300, the fingerprint hash 310 is generated in 216, 222 also based on an additional time difference, an additional frequency difference and an additional amplitude difference. This increases the uniqueness of the fingerprint hashes 310, but puts a higher demand on the audio quality (fulfilled by an audio stream 150 coming from a live stream and original recording). The allocation of the 32 bits for the fingerprint hash 310 described in FIG. 3 need to be tweaked a little bit, since moving to 64 bits would effectively double the storage space required.

In an embodiment, the additional time difference is defined between the first time offset T1 and the third time offset T3, the additional frequency difference is defined between the first frequency F1 and the third frequency F3, and the additional amplitude difference is defined between the first amplitude A1 and the third amplitude A3. In an alternative embodiment, the additional time difference is defined between the second time offset T2 and the third time offset T3, the additional frequency difference is defined between the second frequency F2 and the third frequency F3, and the additional amplitude difference is defined between the second amplitude A2 and the third amplitude A3.

In an embodiment, for each first peak 300, after the generating in 222, an additional hash function is applied in 216, 224 on the fingerprint hash 310. The additional hash function may be any suitable hash function, including but not limited to cryptographic hash functions (such as SHA-1). The additional hash function may spread out the values better and cause fewer collisions.

In an embodiment illustrated in FIG. 3, for each first peak 300, the fingerprint hash 310 and the first time offset T1 are stored in a same data structure 320 in 216, 226. The data structure may be 64 bits long, the first 32 bits are the fingerprint hash 310, and the final 32 bits describe the first time offset T1. The first time offset T1 is important when matching two audio files since not only should they produce the same fingerprint hashes, but they should also come in a correct temporal order.

In an embodiment, tracks are obtained in 228, each track comprising stored fingerprint hashes, and the generated fingerprint hashes 310 of the audio stream 150 are recursively matched in 230 against the stored fingerprint hashes of the tracks using match time offsets between the audio stream 150 and each track in order to identify the audio stream 150.

In order to match an audio stream 150 to the available music in a storage 130, some known good music needs to be indexed. Two tables may be created, a track table and a fingerprint hash table. The track table has an increment identifier and a name field for the song. The fingerprint hash table has one entry for every fingerprint hash in a track, each entry also storing the track identifier and the position of the fingerprint hash. The tables may be stored in a storage 120.

For an unknown audio stream 150, every instance of the fingerprint hashes obtained from the audio are fetched. For every track, the data in a chart is arranged so that the offset is the current stream's position minus the hash position. For a specific audio stream 150 this may be as follows, for example:
10 minutes, the first fingerprint hash of a song is detected;
10 minutes=60*10 seconds=60*10*10 samples/positions in second=position 6000;
song position is 0.6 second, or position 6;
this offset is 6000−6=5994;
2 seconds passes and the second fingerprint hash is detected;
stream position is now 6020 and the next fingerprint hash position is 26;
this offset is 6020-26=5994.

FIG. 6 illustrates an embodiment, wherein different offsets in the x-axis results in corresponding counts of matching hashes in the y-axis. A strong match is detected on an offset of 1063. This means that a lot of the fingerprint hashes do not only occur in this track, but are also in the correct order and time offset from each other.

In an embodiment, the matching in 230 comprises: taking in 232 into account a varying playback speed of the audio stream 150 by, when finding a matching stored fingerprint hash of a specific track, searching for earlier stored fingerprint hashes of the specific track, and if the matching stored fingerprint is by an allowable deviation within a previously used match time offset, accepting the matching stored fingerprint hash into a sequence of matches of the specific track.

If the audio stream 150 differs in playback speed, which seems to be common in real life, the matches may not be so easily detectable as in FIG. 6. FIG. 7 illustrates an embodiment, wherein the audio stream 150 plays its track in 99% of the original speed. The position is now not in one column but in four adjacent columns due to the offset constantly increasing. For a small data set, an acceptable solution may be to just count clusters of columns as a single peak. The issue is that there are millions of songs and it also needs to be known which version of the song is played in the audio stream 150 (for example, whether it is the 1997 version or the 2011 remaster of a song).

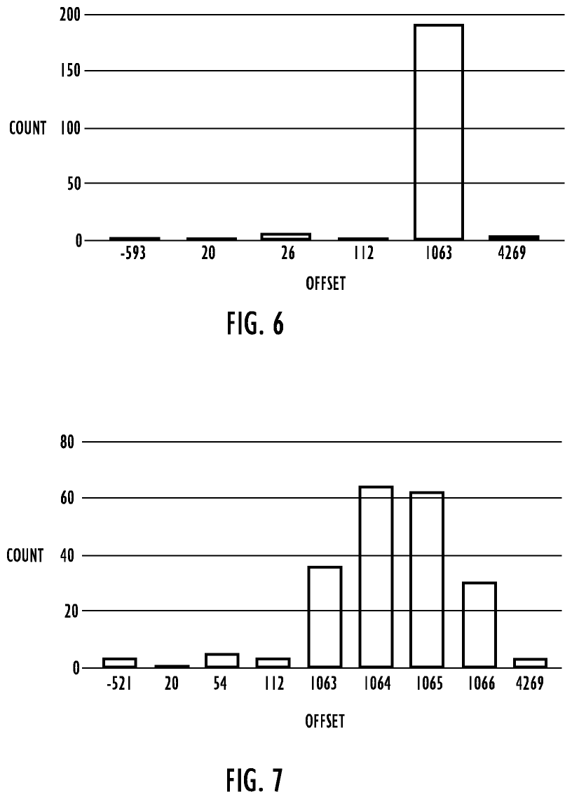

The issue may be solved by working with the sequence of matches, which may also be called a streak. Every time a matching fingerprint hash is found, the operation 148 looks back at the previous peaks from the same track. If the newly found peak time offset is within a predetermined margin (such as 5%) of an existing peak, a score is assigned equal to the existing peak+1 with a slight penalty based on the time offset. If there are more than one matching peak, the top score is used. This not only accounts for music that plays slightly too fast or slow, but it also allows audio that is played at varying speeds to be recognized. The streak is considered to end when no new peaks have been added over a predetermined time period (such as the last 10 seconds) and the result is presented. The part of the original audio that was matched may be calculated using the first and final peaks positions. If the goal is to find the best match, the streak with the highest score over a minimum threshold is the answer. If things like samples from other audio is important, every single streak over a certain threshold may be valuable. FIG. 5 illustrates an example of a streak. The x-axis illustrates the audio stream position, and the y-axis illustrates the offset. Matches 5, 6, 7 and 8 are found with an offset 23, matches 9, 10, 11, 12 and 13 with an offset 24, matches 13, 14, 15 and 16 with an offset 25, and a match 17 with an offset 26. The streak is formed by matches 5-17 depicting the continuous curve. Note that matches 1 and 2 with an offset 28, and a match 9 with an offset 21 do not belong to the streak. As the offset increases in the streak, it indicates that the audio stream 150 plays the identified track slower than in the stored track.

Even though the invention has been described with reference to one or more embodiments according to the accompanying drawings, it is clear that the invention is not restricted thereto but can be modified in several ways within the scope of the appended claims. All words and expressions should be interpreted broadly, and they are intended to illustrate, not to restrict, the embodiments. It will be obvious to a person skilled in the art that, as technology advances, the inventive concept can be implemented in various ways.

1. An apparatus for processing an audio stream, comprising:
one or more processors configured to cause performance of at least the following:
obtaining first peaks of an audio stream, wherein the first peak comprises a first peak amplitude at a first frequency and at a first time offset from a beginning of the audio stream;
for each first peak, detecting a second peak in a window with a predetermined offset from the first peak, wherein the second peak comprises a second peak amplitude at a second frequency and at a second time offset from the beginning of the audio stream; and
for each first peak, generating a fingerprint hash based on the first frequency, a time difference between the first time offset and the second time offset, a frequency difference between the first frequency and the second frequency, and an amplitude difference between the first amplitude and the second amplitude.

2. The apparatus of claim 1, wherein the one or more processors are configured to cause performance of at least the following:
for each first peak, detecting also a third peak in the window with the predetermined offset from the first peak, wherein the third peak comprises a third peak amplitude at a third frequency and at a third time offset from the beginning of the audio stream; and
for each first peak, generating the fingerprint hash also based on an additional time difference, an additional frequency difference and an additional amplitude difference.

3. The apparatus of claim 2, wherein the additional time difference is defined between the first time offset and the third time offset, the additional frequency difference is defined between the first frequency and the third frequency, and the additional amplitude difference is defined between the first amplitude and the third amplitude.

4. The apparatus of claim 2, wherein the additional time difference is defined between the second time offset and the third time offset, the additional frequency difference is defined between the second frequency and the third frequency, and the additional amplitude difference is defined between the second amplitude and the third amplitude.

5. The apparatus of claim 1, wherein the one or more processors are configured to cause performance of at least the following: for each first peak, after the generating, applying an additional hash function on the fingerprint hash.

6. The apparatus of claim 1, wherein the one or more processors are configured to cause performance of at least the following:
for each first peak, storing the fingerprint hash and the first time offset in a same data structure.

7. The apparatus of claim 1, wherein the obtaining comprises:
transforming the audio stream from a time-domain to a frequency-domain; and
analyzing the audio stream in the frequency-domain to detect the first peaks.

8. The apparatus of claim 7, wherein the transforming comprises:
using a Fourier to transform the audio stream into a spectrogram describing audio amplitudes at different frequencies over time.

9. The apparatus of claim 1, wherein the obtaining comprises:
limiting the audio stream to a subset of a full frequency range of the audio stream.

10. The apparatus of claim 1, wherein the obtaining comprises:
dividing the audio stream into a predetermined number of frequency bands; and
using a decaying threshold value for each frequency band to detect the first peaks.

11. The apparatus of claim 1, wherein the window with the predetermined offset from the first peak covers a predetermined amount of frequency spectrum both above and below the first frequency.

12. The apparatus of claim 1, wherein the one or more processors are configured to cause performance of at least the following:
obtaining tracks, each track comprising stored fingerprint hashes; and
matching recursively the generated fingerprint hashes of the audio stream against the stored fingerprint hashes of the tracks using match time offsets between the audio stream and each track in order to identify the audio stream.

13. The apparatus claim 12, wherein the matching comprises: taking into account a varying playback speed of the audio stream by, when finding a matching stored fingerprint hash of a specific track, searching for earlier stored fingerprint hashes of the specific track, and if the matching stored fingerprint is by an allowable deviation within a previously used match time offset, accepting the matching stored fingerprint hash into a sequence of matches of the specific track.

14. The apparatus of claim 1, wherein the one or more processors comprise:
one or more memories including computer program code; and
one or more processors configured to execute the computer program code to cause performance of the apparatus.

15. A method for processing an audio stream, comprising:
obtaining first peaks of an audio stream, wherein the first peak comprises a first peak amplitude at a first frequency and at a first time offset from a beginning of the audio stream;
for each first peak, detecting a second peak in a window with a predetermined offset from the first peak, wherein the second peak comprises a second peak amplitude at a second frequency and at a second time offset from the beginning of the audio stream; and
for each first peak, generating a fingerprint hash based on the first frequency, a time difference between the first time offset and the second time offset, a frequency difference between the first frequency and the second frequency, and an amplitude difference between the first amplitude and the second amplitude.

16. A computer-readable medium comprising computer program code, which, when executed by one or more processors, causes performance of a method for processing an audio stream, comprising:
obtaining first peaks of an audio stream, wherein the first peak comprises a first peak amplitude at a first frequency and at a first time offset from a beginning of the audio stream;
for each first peak, detecting a second peak in a window with a predetermined offset from the first peak, wherein the second peak comprises a second peak amplitude at a second frequency and at a second time offset from the beginning of the audio stream; and
for each first peak, generating a fingerprint hash based on the first frequency, a time difference between the first time offset and the second time offset, a frequency difference between the first frequency and the second frequency, and an amplitude difference between the first amplitude and the second amplitude.
